(19) United States
(12) Patent Application Publication
(10) Pub. No.: US 2015/0020020 A1
(43) Pub. Date: Jan. 15, 2015

(54) MULTI-DIMENSIONAL CONTENT PLATFORM FOR A NETWORK

(71) Applicant: CRACKPOT INC., LAS VEGAS, NV (US)

(72) Inventor: Stephen White, Las Vegas, NV (US)

(21) Appl. No.: 14/206,864

(22) Filed: Mar. 12, 2014

Related U.S. Application Data
(63) Continuation-in-part of application No. 14/178,380, filed on Feb. 12, 2014.
(60) Provisional application No. 61/930,448, filed on Jan. 22, 2014.
(60) Provisional application No. 61/903,180, filed on Nov. 12, 2013.
(60) Provisional application No. 61/845,005, filed on Jul. 11, 2013.

(51) Int. Cl. G06F 3/0482; G06F 3/0484

(52) U.S. Cl. CPC G06F 3/0482; G06F 3/04842
USPC 715/783

(57) ABSTRACT

Apparatus, system and method for presenting content in a multi-dimensional format is disclosed. A communication apparatus is configured to communicate data to a network, and a storage is operatively coupled to the communication apparatus. The storage is configured to store data to be presented to a user via the network. A processor may be configured to process the data to generate a presentation form for the data, wherein the presentation form includes a polyhedron having a plurality of faces, wherein each face of the polyhedron includes a portion of the data on each face. The presentation form may further include a secondary form that is nested within an area inside the polyhedron. The presentation form is then communicated for presentation to the user. A portable device is also disclosed for controlling and interacting with the presentation form.

### RELATED APPLICATIONS

The present application is a continuation-in-part of U.S. Non-Provisional patent application Ser. No. 14/178,380 to White et al., titled “Multi-Dimensional Content Platform for a Network,” filed Feb. 12, 2014, which claims priority to U.S. Provisional Patent Application No. 61/845,005 to White et al., titled “Engine, System and Method of Providing Interactive Content Delivery Management”, filed Jul. 11, 2013, U.S. Provisional Patent Application No. 61/903,180 to White et al., titled “Systems and Method for Mobile Social Network Interactions” filed Nov. 12, 2013, and U.S. Provisional Patent Application No. 61/930,448 to Stephen White, titled “System and Methods for Delivery Information and a Platform for Same” filed Jan. 22, 2014, each of which are incorporated by reference in their entirety herein. The present application is also related to U.S. Non-Provisional patent application Ser. No. 14/178,367 to White et al., titled “Computer-Implemented Virtual Object for Managing Digital Content,” which is filed contemporaneously with this application and is also incorporated by reference in its entirety herein.

### TECHNICAL FIELD

The present invention relates to the control, presentation and distribution of information and media content, and, more particularly, to an engine, system and method of providing nested interactive content delivery management.

### BACKGROUND INFORMATION

Content developers have long struggled with finding efficient and effective ways to deliver content to users. Traditionally, content developers have relied on a “windows-based” approach for presenting content, where content is commonly presented on overlaid, two-dimensional windows, where an active window often obscures or blocks inactive windows underneath. This inevitably results in the drawback of users having to serially access content one window at a time. If enough windows are simultaneously open, this can often confuse and frustrate a user. Furthermore, the windows are note easily linked to other windows in order to combine related content. Typically, content is combined within a single window (e.g., under a common domain name), and related content may only be accessed by opening a second window, which again results in the original window being obscured and/or blocked by the second window.

Developers have attempted to address these issues in a number of ways. One existing solution has been to introduce tabs within a two-dimensional window to allow users to “tab” between content. However, this approach continues to have the drawback of limiting the user to viewing or interacting with one tab at a time, similar to the windows approach, discussed above. Additionally, the tabs are not linked according to content. Another existing solution has been to present content as “tiles” on a screen. Typically, each tile is presented as a thumbnail version of the original page. While this has allowed users to view content simultaneously, the approach has additional drawbacks. For one, the miniature tiles are often difficult to see for the user. Further, since the tiles are presented in a two-dimensional format, they take up an unnecessarily large portion of screen “real estate.” If the number of tiles exceeds the allotted screen space, users often have to “page” through the tiles, which results in the removal of large numbers of tiles from view. Moreover, tiles cannot be easily linked on the content developers side; often times, this requires users to manually create folders to hold groups of tiles.

Accordingly, what is needed is a system, apparatus and/or method to provide effective and efficient presentation of content to users. By going past the limitations of 2-dimensional constructs (i.e., windows and/or tiles), multiple levels of content may be presented to users. Furthermore, by using multi-dimensional platforms for content presentation, the ability to intermingle or “nest” content becomes a particularly powerful feature. Accordingly, various levels may be viewed and/or interacted with globally through a unique interface, allowing users to have a better experience with both on-line and stored content.

### BRIEF SUMMARY

Under one exemplary embodiment, a system is disclosed, comprising a communication apparatus for communicating data to a network, and a storage, operatively coupled to the communication apparatus, wherein the storage is configured to store data to be presented to a user via the network. A system processor, operatively coupled to the storage, is configured to process the data to generate a presentation form for the data, wherein the presentation form comprises a polyhedron comprising a plurality of faces, and wherein each face of the polyhedron comprises a portion of the data on each face. The presentation form may also include a secondary form, nested within an area of the polyhedron, wherein the secondary form comprises secondary data that is related to the data to be presented to the user. The processor is further configured to transmit the presentation form to the communication apparatus for presentation to the user.

In other exemplary embodiments, the data and secondary in the system comprises at least one of graphical data, audio data, streaming media data, video data, text, web page, hyperlink, metadata and image data. The processor may be configured to group the data on each face of the polyhedron according to a predetermined category, ad further configure the secondary form based on the grouping. In other exemplary embodiments, the system may receive user data in the communication apparatus in response to the transmission of the presentation form. The user data may comprise data relating to at least one (i) the user's exposure to and/or the user's interaction with data from at least one face of the presentation form, and (ii) the user's exposure to and/or the user's interaction with the secondary data. The processor in the system may also be configured to retrieve further data for the presentation form and transmit the further data to the user in response to receiving the user data. The further data may comprise additional data relating to at least one of (i) the at least one face the user interacted with, (ii) a face different from the at least one face the user interacted with in the presentation form, and (iii) the secondary form the user interacted with. The secondary form may be configured as a two-dimensional object, or a three-dimensional object.

In another exemplary embodiment, a portable computing device is disclosed, comprising a communication apparatus for communicating with a network, a storage apparatus, operatively coupled to the communication apparatus, a processor, operatively coupled to the storage, and a user input apparatus, operatively coupled to the processor. The user input apparatus may be configured to allow a user to control an aspect of operation in the processor, wherein the communication apparatus is configured to receive a presentation form from the network, said presentation form comprising a polyhedron comprising a plurality of faces, wherein each face of the polyhedron comprises different presentation data on each face. The presentation form may further comprise a secondary form, nested within an area of the polyhedron, wherein the secondary form comprises secondary data that is related to the data to be presented to the user. The processor may be further configured to present the presentation form to the user in the portable computing apparatus, and (i) allow the user to control the polyhedron and secondary form via the user input apparatus and (ii) access the presentation data and secondary data via the user input apparatus.

In other exemplary embodiments, the presentation data and secondary data for the portable computing device comprises at least one of graphical data, audio data, streaming media data, video data, text, web page, hyperlink, metadata and image data. The presentation data may be grouped on each face of the polyhedron according to a predetermined category. The secondary form may be configured based on the grouping of data. In other exemplary embodiments, the portable computing device is configured to transmit user data to the communication apparatus in response to the user accessing the presentation data. The processor in the portable computing device may be configured to receive further data for the presentation form via the communication apparatus in response to transmitting the user data. The further data may comprise additional data relating to at least one of (i) the at least one face the user interacted with, (ii) a face different from the at least one face the user interacted with in the presentation form, and (iii) the secondary form the user interacted with. The secondary form may be configured as a two-dimensional object, or a three-dimensional object.

In another exemplary embodiment, a processor-based method is disclosed for transmitting content over a network. The method may comprise the steps of retrieving data to be presented to a user from a storage, and processing the data in a processor to generate a presentation form for the data, wherein the presentation form comprises a polyhedron comprising a plurality of faces, and wherein each face of the polyhedron comprises a portion of the data on each face. The presentation form may comprise a secondary form, nested within an area of the polyhedron, wherein the secondary form comprises secondary data that is related to the data to be presented to the user. The presentation form may be transmitted to a communication apparatus for presentation to the user.

In other exemplary embodiments, the data and secondary data comprises at least one of graphical data, audio data, streaming media data, video data, text, web page, hyperlink, metadata and image data. The data may be grouped on each face of the polyhedron according to a predetermined category and the secondary data may be configured on the secondary form based on the grouping of data. In other exemplary embodiments, user data may be received in the communication apparatus in response to the transmission of the presentation form. The user data may comprise data relating to at least one of (i) the user's exposure to and/or the user's interaction with data from at least one face of the presentation form, and (ii) the user's exposure to and/or the user's interaction with the secondary data. Further data may be retrieved for the presentation form and transmitted to the user in response to receiving the user data. The further data may comprise additional data relating to at least one of (i) the at least one face the user interacted with, (ii) a face different from the at least one face the user interacted with in the presentation form, and (iii) the secondary form the user interacted with. The secondary form may be configured as a two-dimensional object, or a three-dimensional object.

### BRIEF DESCRIPTION OF THE DRAWINGS

The present invention is illustrated by way of example and not limitation in the figures of the accompanying drawings, in which like references indicate similar elements and in which:

FIG. 1 illustrates a computer system for providing cube delivery and communications under one exemplary embodiment;

FIG. 2 illustrates another system for providing cube delivery and communications for a plurality of different devices under another exemplary embodiment;

FIG. 3 illustrates an exemplary polyhedron shape or cube for presentation and interaction to a user under one embodiment;

FIG. 4 illustrates an exemplary graphical user interface for creating/generating cubes under one embodiment;

FIG. 5 illustrates an exemplary interface for linking user data to a cube under one embodiment;

FIG. 6 illustrates a graphical user interface or associating one or more cubes to one or more users under another exemplary embodiment;

FIG. 7 illustrates a dashboard for monitoring and managing cube purchases and related cube data under an exemplary embodiment;

FIG. 8 illustrates an interface for associating network domains to a cube under one exemplary embodiment;

FIG. 9 illustrates an exemplary embodiment where a plurality of sides of a cube are simultaneously exposed to a user;

FIG. 10 illustrates a system wherein a cube may be presented in various forms at various locations under an exemplary embodiment;

FIG. 11 illustrates another system for creating, presenting and managing cube distribution and cube data under an exemplary embodiment;

FIG. 12 illustrates another exemplary device that is used to receive and provide interaction with a cube for a user under one embodiment;

FIG. 13A illustrates a cube comprising nested content inside the cube and is configured to expand the nested content for presentation to a user under one exemplary embodiment;

FIG. 13B illustrates the cube of FIG. 13A, where the nested content is expanded for presentation to a user;

FIG. 14A illustrates a cube comprising nested three-dimensional content inside the cube and is configured to expand the nested content for presentation to a user under one exemplary embodiment; and

FIG. 14B illustrates the cube of FIG. 14A, where the three-dimensional nested content is expanded for presentation to a user.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

Computer-implemented platforms, engines, systems and methods of use are disclosed herein that provide networked access to a plurality of types of digital content, including but not limited to video, image, text, audio, metadata, interactive and document content, and that track, deliver, manipulate, transform and report the accessed content. Described embodiments of these platforms, engines, systems and methods are intended to be exemplary and not limiting. As such, it is contemplated that the herein described systems and methods can be adapted to provide many types of cloud-based valuations, scoring, marketplaces, and the like, and can be extended to provide enhancements and/or additions to the exemplary platforms, engines, systems and methods described. The invention is thus intended to include all such extensions.

Furthermore, it will be understood that the term “module” as used herein does not limit the functionality to particular physical modules, but may include any number of tangibly-embodied software and/or hardware components. In general, a computer program product in accordance with one embodiment comprises a tangible computer usable medium (e.g., standard RAM, an optical disc, a USB drive, or the like) having computer-readable program code embodied therein, wherein the computer-readable program code is adapted to be executed by a processor (working in connection with an operating system) to implement one or more functions and methods as described below. In this regard, the program code may be implemented in any desired language, and may be implemented as machine code, assembly code, byte code, interpretable source code or the like (e.g., via C, C++, C#, Java, Actionscript, Objective-C, Javascript, CSS, XML, etc.).

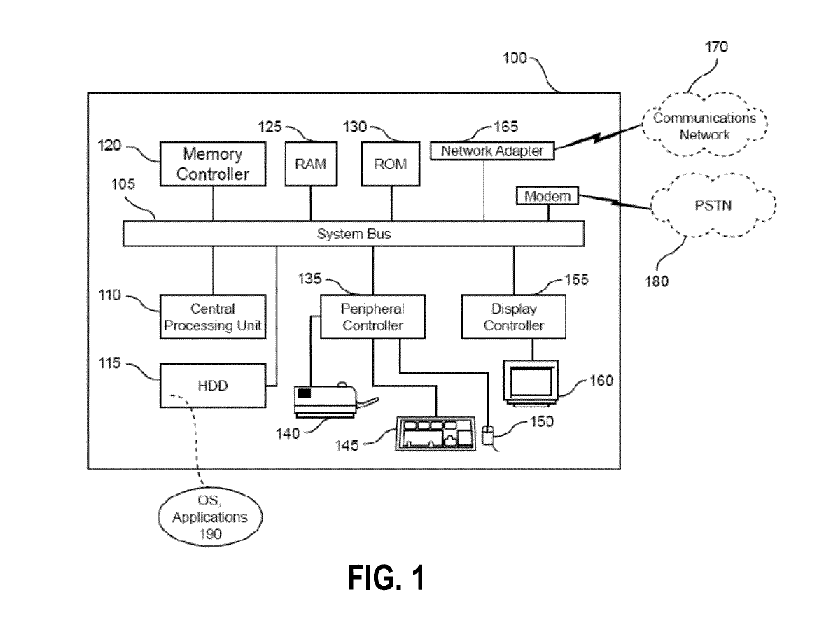

FIG. 1 depicts an exemplary computing system 100 for use in accordance with certain system and methods disclosed herein under various embodiments. Computing system 100 is capable of executing software, such as an operating system (OS) and a variety of computing applications 190. The operation of exemplary computing system 100 is controlled primarily by tangibly-embodied computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, and the like, CPU 110 is implemented in an integrated circuit, or a processor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Such instructions can be included in software such as an operating system (OS), executable programs, and the like. Information, such as computer instructions and other computer readable data, is transferred between components of computing system 100 via the system's main data-transfer path. The main data-transfer path may use a system bus architecture 105, although other computer architectures (not shown) can be used, such as architectures using serializers and deserializers and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, computing system 100 may contain peripheral controller 135 responsible for communicating instructions using a peripheral bus from CPU 110 to peripherals, such as printer 140, keyboard 145, and mouse 150. An example of a peripheral bus is the Peripheral Component Interconnect (PCI) bus.

Display 160, which is controlled by display controller 155, can be used to display visual output and/or presentation generated by or at the request of computing system 100. Such visual output may include text, graphics, animated graphics, and/or video, for example. Display 160 may be implemented with a CRT-based video display, an LED or LCD-based flat-panel display, gas plasma-based flat-panel display, touch-panel, or the like. Display controller 155 includes electronic components required to generate a video signal that is sent to display 160.

Further, computing system 100 may contain network adapter 165 which may be used to couple computing system 100 to an external communication network 170, which may include or provide access to the Internet. Communications network 170 may provide user access for computing system 100 with means of communicating and transferring software and information electronically. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

It is appreciated that exemplary computing system 100 is merely illustrative of a computing environment in which the herein described systems and methods may operate and does not limit the implementation of the herein described systems and methods in computing environments having differing components and configurations, as the inventive concepts described herein may be implemented in various computing environments using various components and configurations.

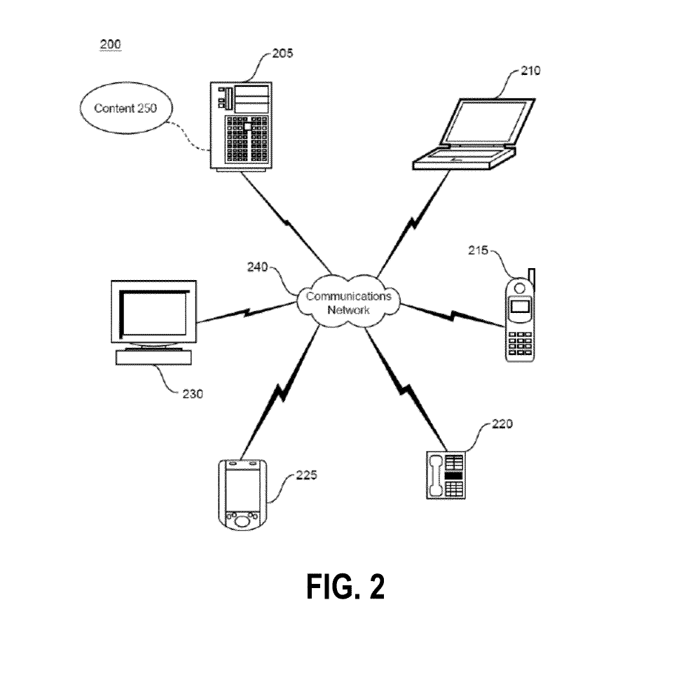

Turning now to FIG. 2, computing system 100 is disclosed that may be deployed in networked computing environment 200. In general, the above description for computing system 100 applies to server, client, and peer computers deployed in a networked environment, for example, server 205, laptop computer 210, and desktop computer 230. FIG. 2 illustrates an exemplary illustrative networked computing environment 200, with a server in communication with client computing and/or communicating devices via a communications network, in which the herein described apparatus and methods may be employed.

As shown in FIG. 2, server 205 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer 210, wireless mobile telephone 215, wired telephone 220, personal digital assistant 225, user desktop computer 230, and/or other communication enabled devices (not shown). Server 205 can comprise dedicated servers operable to process and communicate data such as digital content 250 to and from client devices 210, 215, 220, 225, 230, etc. using any of a number of known protocols, such as hypertext transfer protocol (HTTP), file transfer protocol (FTP), simple object access protocol (SOAP), wireless application protocol (WAP), or the like. Additionally, networked computing environment 200 can utilize various data security protocols such as secured socket layer (SSL), pretty good privacy (PGP), virtual private network (VPN) security, or the like. Each client device 210, 215, 220, 225, 230, etc. can be equipped with an operating system operable to support one or more computing and/or communication applications, such as a web browser (not shown), email (not shown), or the like, to interact with server 205.

Under one exemplary embodiment, a widget may be provided which may allow for the portability of content between devices held or operated by a user. Such a widget may be presented as a polygonal or polyhedron shape so as to provide segmentation of the provided content and make such content more easily accessible and viewable by the user. Such a shape may preferably be a cube, but may also be in the form of a segmented sphere, a diamond, a cylinder, a pyramid and/or any other shape desired and/or considered practical by those skilled in the art. One of the advantages of providing content in a polyhedron format is that multiple type or forms of contact may be presented simultaneously to a user, which allows for easier navigation of such content. Additionally, it provides content developers with options to bundle similar or related content together for immediate user interaction. It should be understood that the present disclosure may be adapted to accommodate any polyhedron, sphere, cylinder or other 3-dimensional shape for presenting content to a user. Nevertheless, for the sake of simplicity, the disclosure will refer to the 3-dimensional presentation form for content as a “cube” throughout this disclosure.

A cube may be viewed as an object within a graphical user interface (GUI), and may be viewed in any orientation. The cube may, for example, be manipulated in any direction by the user to more easily access the information contained therein and/or to view the content contained within the cube. The visualization of the information contained within the cube may be projected on one or more sides of the cube. For example, a user may wish to upload one or more pictures which may be viewed and/or accessed from the cube. The user may choose to load content to one particular side of the cube or assign one particular side with content information related to, for example, pictures and have the content information and/or pictures either viewable and/or accessible through at least one side of the cube. Thus, by activating a particular side or designated portion of the cube, the user may interact with a portion of the cube, e.g., view a slide show of the loaded pictures. Under one exemplary embodiment, the primary content (i.e., the content which the user is currently interacting with, typically the front face or side of the cube) is displayed normally, while secondary content (i.e., content on one or more other sides of the cube or shape), is dimmed, rendered translucent or semitransparent, etc. to allow the user to both interact with content and see secondary content simultaneously, with minimized distraction. Continuing with the example, the user may also access the pictures uploaded to the cube by clicking or otherwise activating the picture side of the cube. As would be appreciated by those skilled in the art, the uploaded images may be cropped and/or manipulated to best fit the size and shape of the cube and to provide the user with the necessary editing capabilities to create the desire outcome.

Of course, content to the cube is not limited to images only. Any electronically based content and/or media may be associated with the cube and/or viewable through the cube. For example, video, audio, RSS feeds, email correspondence, web pages, URL links, social media access, such as, for example, Facebook and Twitter feeds, documents, file uploads, FTPs, and the like. By way of non-limiting example only, a user may associate a blog with one portion of the cube. Such an association may allow for a real time update and interaction with the blog by the user through the cube. Such an association may allow the user to access and/or interact with the blog through having access only to the cube and without having direct access to the blog. In this way, a user need only avail themselves of access to the cube rather than access to all the content otherwise associated with the cube.

For example, images uploaded to the cube may have originated from a desktop environment of the user and may be inaccessible by the user outside of direct contact or access to the desktop environment. Therefore, if the user has access to the cube via some other means of interaction, such as, through a smart phone device, the user may still have the ability to access the photos on the cube. As would be appreciated by those skilled in the art, the content associated with the cube may be uploaded into a cloud computing environment which may offer dedicated storage access and/or capabilities for the cube or the cube may simply access content through addressing the content directly. Content not otherwise uploaded into storage directly associated with the cube may be accessed through a mobile device may link directly into the desktop environment where the pictures are located in order to more fully access or view the desired media.

As discussed herein, the cube and/or widget may be imported and/or resident on any device desired by the user. For example, the cube may be resident on a user's desktop environment as an icon and/or a free embodied feature which may be continually viewed and/or accessed by the user regardless of other desktop functionality. Being associated with a particular cube having particular content, the user may call the cube to other devices such as, for example, a smart phone. By way of further example, the cube may be called at any electronic device such as, for example, a kiosk which may be placed in a shopping mall, a retail store, a city government building, a parking garage, and/or any other place providing access to the public. In this way, the cube offers the user the ability to access, deliver, and port information and content to any location for which the user has possession of an electronic device.

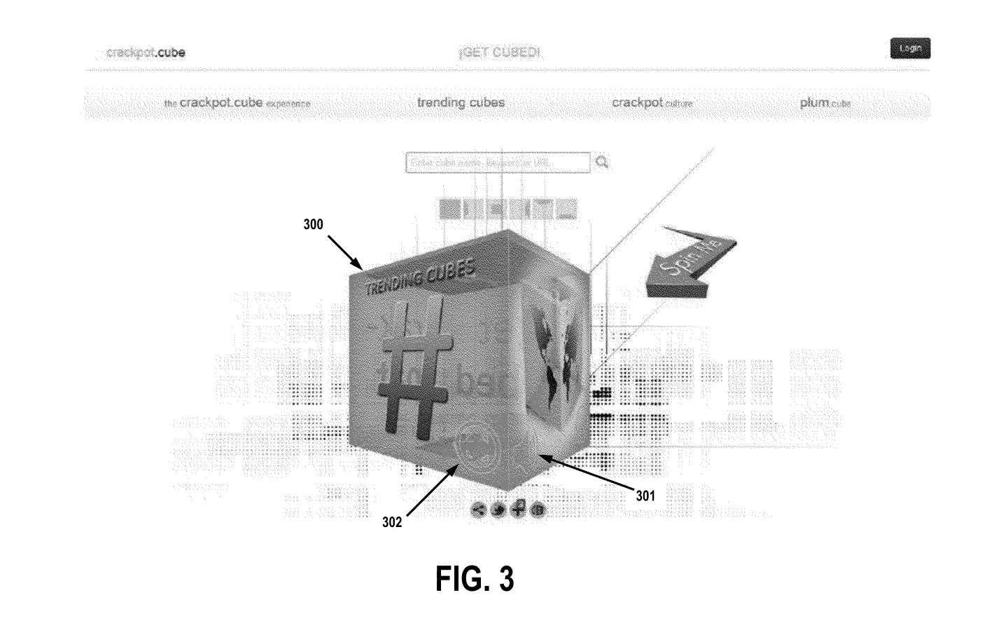

As illustrated in FIG. 3, an embodiment of the cube 300 may allow for a semitransparent graphical representation. In such an embodiment, the user may not only be able to visually identify content present on various sides of the cube, but may also visually discern what information under a content the cube may be otherwise blocking such as, for example, features of a desktop and/or mobile interface. As illustrated in FIG. 3, cube 300 has included thereon audio 301 on at least one side of the cube. Access to the audio 301 may be presented to the user in a variety of ways, but may be provided through interaction with an icon denoting an audio file as illustrated. Similarly, and as discussed hereinabove, although content may be cropped and/or edited to be more visually accommodated within a side of the cube, functionality may be provided to expand within the cube or the cube itself the information contained within the cube. For example, an expansion icon 302 as illustrated on the left side of the cube in FIG. 3 may be provided to allow for manipulation of that particular side of the cube. In this way, a user may interact with a particular side of the cube without leaving the cube environment.

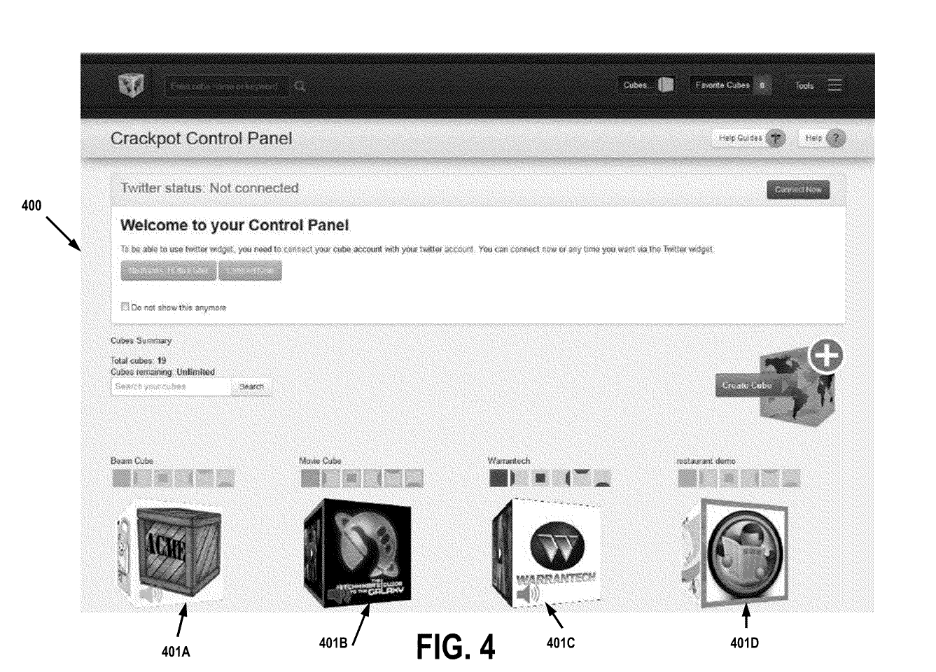

As illustrated in FIG. 4, the present invention may provide a GUI 400 which may allow for the creation of one or more cubes (401A-C) for each user. For example, a user may wish to build a cube devoted to a particular subject and/or topic which may allow a user to better organize his or her access to content. Thus, such a particular cube may be devoted to social media which may, for example, include a cube having a side devoted to a Twitter® feed, a side devoted to a Facebook® feed, a side devoted to Google® Circles, a side devoted to YouTube® videos, a side devoted to a picture album, a side devoted to text messaging, a side devoted to email, and/or a side devoted to voice calls. Having a cube devoted to a particular subject and/or topic, may allow a user to choose how many cubes to access at a particular time and/or how many cubes may be available between devices controlled by the user.

Continuing with the example of a cube devoted to social media, the at least one side of the cube devoted to a photo album may include individual photos uploaded by the user to the cube, photos and/or images gathered from particular sites, and/or from other cube users or designated users of other social networks. By way of non-limiting example only, a user may associate the photo album on a mobile device such that images captured by the mobile device are automatically provided to the designated portion of the cube. Similarly, images captured by the mobile device may be sent manually and/or by rule to the cube. Such a rule which may be set by the user may include variable such as time of day, location, logged in user, and/or content of the image.

As discussed herein, the social networking cube example may further include a portion dedicated to communication with other cubes and/or other platforms such as, for example, Skype, text messaging, instant messaging, email, Twitter, and/or any other form of instant communication. For example, a communication channel associated with the cube may be left open and/or always logged in such that the user may have relative instant access to such a channel. By way of further example, a user may associate with at least one side of the cube a communication tool such as, for example, Skype®, which may be left open such that the user may interact with that portion of the cube to instantaneously access Skype and/or may be alerted either visually and/or audibly to activity within Skype through the open channel on the cube. Furthermore, as will be discussed in more detail herein, because the cube may be shared by the user with other third parties, communication channels, for example, may be shared across multiple devices with multiple users.

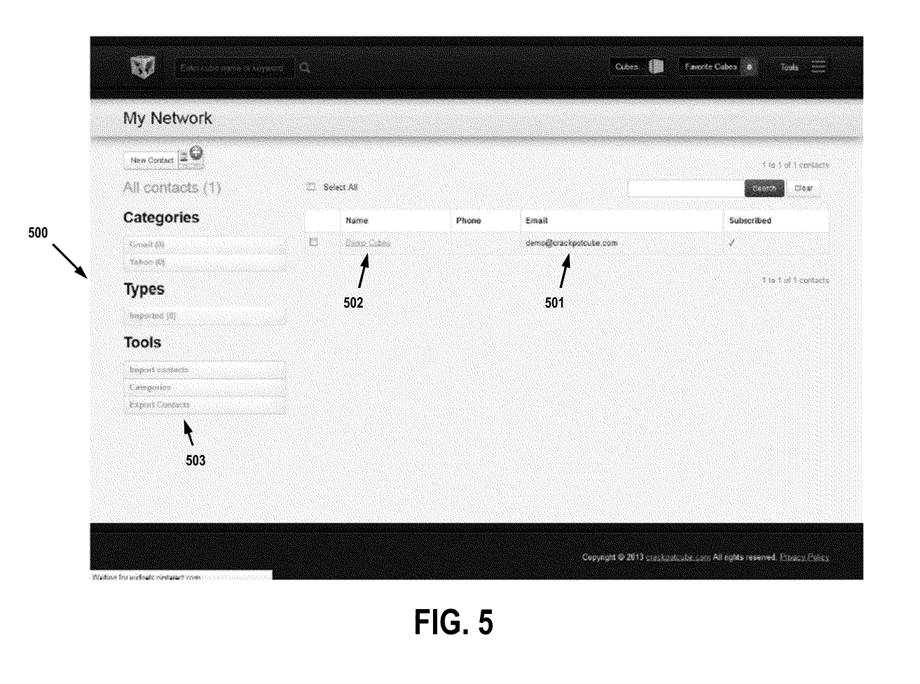

As illustrated in FIG. 5, the present invention may provide an interface 500 the user the ability to associate the cube with specific contact information such as from an email 501, for example, and may allow a user to provide a description and/or name 501 for each cube the user may create. The user may also have the ability to quickly share a created cube with one or more third parties and may, for example, choose a new contact from contacts which may exist either within the interface provided through the present invention and/or accessed from such programs such as Outlook, for example. The network of contacts illustrated in FIG. 5 further provides the user with the ability to organize contacts via category and type. A tool function 503 may be provided to allow users to manage each of the contacts.

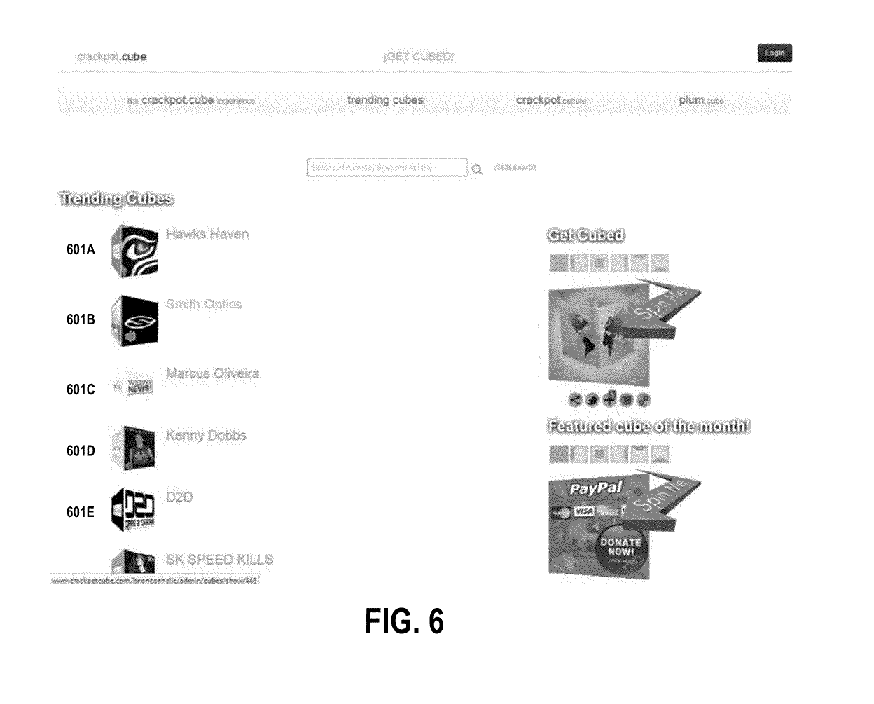

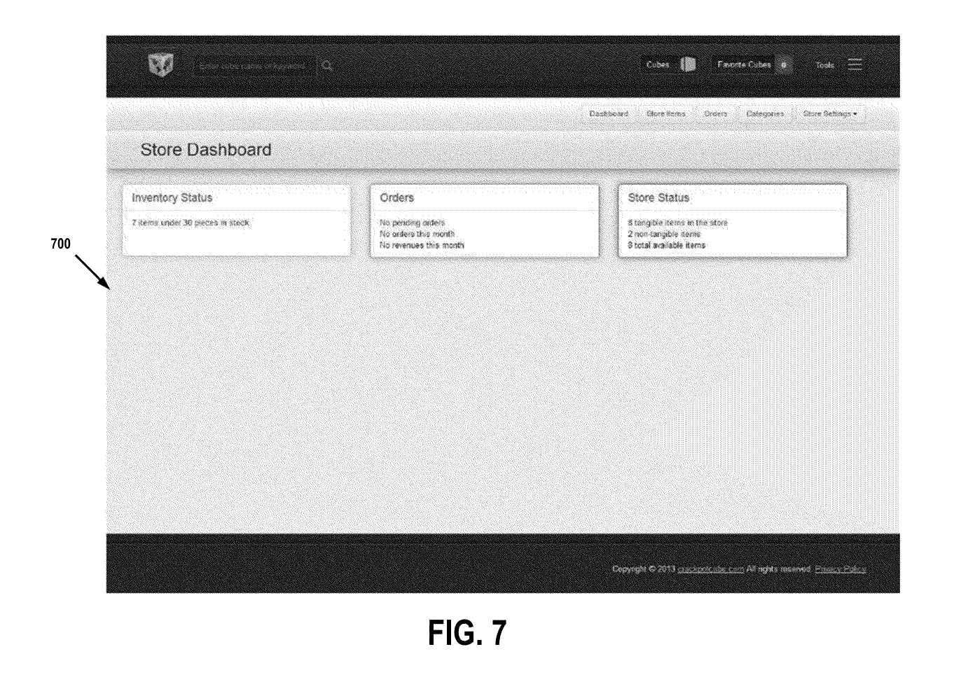

As illustrated in FIG. 6, cubes created by third parties may be available to any user and may be associated with each user as desired. For example, the GUI of the present invention may provide a list of trending cubes and/or cubes determined to be of interest to the user (601A-601E) which may include cubes devoted to particular sporting teams, particular types of products, and/or various aggregations of information, such as, for example, news feeds. By way of example, a news cube may be imported by the user and may include feeds for the major network news outlets and may include such things as live video feeds and/or news alerts. Although many such third party cubes may be provided at no cost, some cubes may be provided at a cost to the user. Such costs may take the form of subscription costs and/or one time fees. Similarly, a cube may be provided wherein a particular side of the cube offers something for purchase to the user. Such as, for example, a service and/or good. As illustrated in FIG. 7, the present invention may provide a dashboard 700 allowing the user to manage the purchase of cubes and/or discrete services and/or of goods.

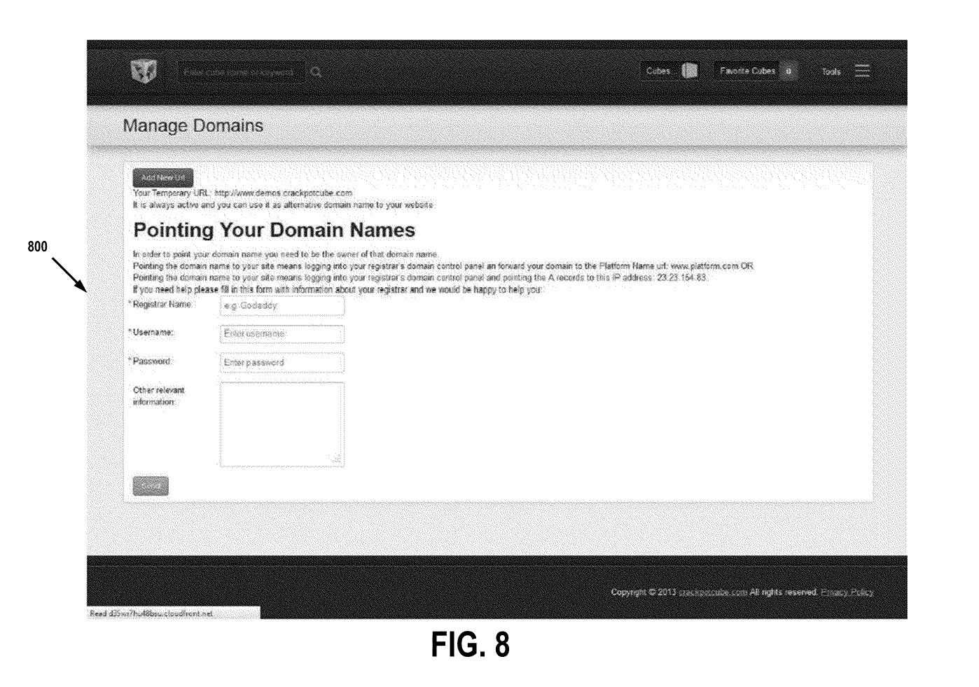

As discussed herein and as illustrated in FIG. 8, an interface 800 may be provided to allow a user to associate a specific domain with a particular side of the cube. Such pointing to a particular domain may provide to the cube direct access to the domain by the user through simple interaction such as, for example, clicking on that side of the cube, it may also allow the content or at least a portion of the content resident at the domain to be pushed to the cube. The pushing of content may allow for such things as enhanced communications with the user of the cube and/or targeted advertising to the user of the cube by the owner of the domain. In an embodiment of the present invention, an advertisement may be delivered through a domain associated with at least one side of the cube based upon the users attributes, the user's interactions with the cube, and/or environmental factors such as, for example, the time of day.

For example, a user may have associated with at least one side of a cube a news outlet such as the New York Times. The New York Times, in turn, may deliver as to the user based on user characteristics, which may include, for example, demographics, interaction history with the New York Times and/or other portions of the cube, and/or location of the user. Thus, if the user is actively engaged with the New York Times through the cube, and/or has a past history of interaction with the New York Times through the cube and is demographically targeted for a particular ad, that ad may be delivered by the New York Times to the face or side of the cube during, for example, periods of no interaction with the New York Times side of the cube. In a similar fashion, an ad from in the New York Times may be delivered to the New York Times side of the cube when the user is interacting with at least one other side of the cube. Thus, alerting the New York Times that the user is visually attuned to the cube and may be more greatly impacted by the delivered ad.

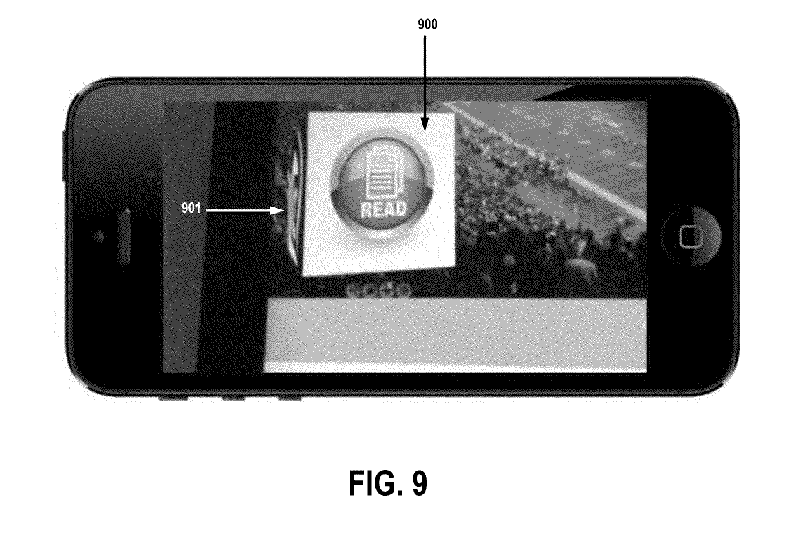

Such an ad delivery may take any number of forms as appreciated by those skilled in the art, and may occur for a period of time such as, for example, five seconds. The delivery of advertisements may also be optimized such that the user has a greater chance of viewing the ad delivered to the cube. In this way, for example, an ad delivered by the New York Times may be delivered to the side of the cube most visually exposed to the user even if that side of the cube is not the side of the cube designated by the user for access to the New York Times. In such an instance, the ad delivered by the New York Times may take priority over the content being viewed by the user on the at least one most prominent side. As illustrated in FIG. 9, for example, the cube may generally have at least two sides (900, 901) exposed to view by the user. In the embodiment illustrated in FIG. 9, the cube is an overlay on video content being viewed on a mobile device by the user. Although a user may wish to minimize or hide the cube behind content being actively viewed, the cube may, as illustrated, be actively assessable over the primary content visible on the device.

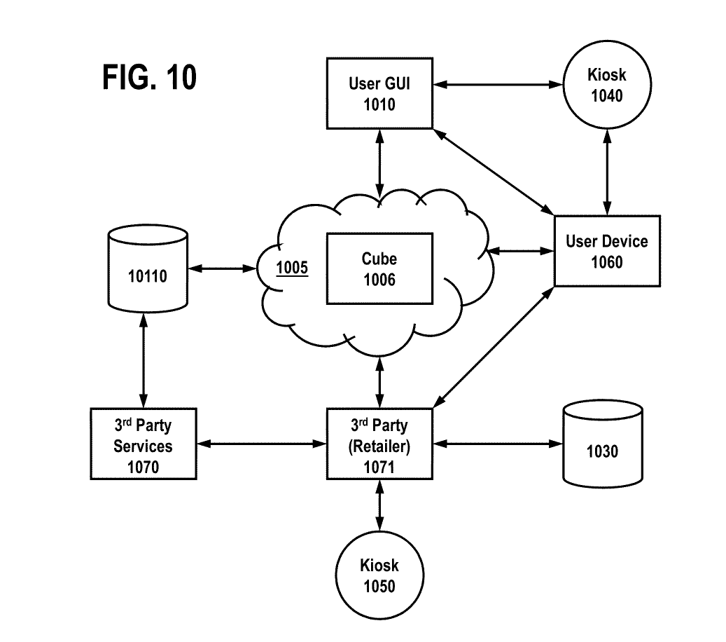

As illustrated in FIG. 10, System 1000 may include at least one cube 1006 within at least one network or cloud environment 1005 which may communicatively allow the cube to be viewed by the user in many forms and in many locations such as, for example, Kiosk 1040, user device 1060, Kiosk 1050, and/or through user GUI 1010, for example. The cubed cloud environment 1005 may have associated with it at least one database 1020 which may allow for the storage of cube content and other points of information such as, for example, URL's, passwords, and the cube interaction history. Database 1020 may also include user characteristics and statistics of use of the cube for access by the user and/or third parties which may use such user statistics to deliver, for example, advertising and/or particular cubes of information.

Kiosk 1050, for example, may be provided at a third party retailer wherein information may be provided about products and/or services offered by or through a third party retailer. By way of example, a large home improvement store may have within its walls at least one Kiosk with access to at least one cube provided by at least one manufacturer. The cube, for example, may be provided by a manufacturer of small power tools and may be provided for access by a user to gain product information and/or support. For example, a customer in the store may access the cube offered by the Kiosk which may in turn have embedded thereon a video demonstrating use of at least one produce offered by the vendor, and/or access to social media and/or live customer service whereby at least one side of the cube includes a portal to a live remote customer service representative. The presented cube may offer not only instant access to information and customer service help, but may also provide contact information for the vendor and/or a coupon for one or more products offered by the vendor and for use within the store for purchase of such a good.

By way of non-limiting example only, a user interacting with a Kiosk may be seeking information regarding a particular power saw, and may seek direct advice from a customer service representative which may allow the user to fully discuss any and all questions regarding the potential purchase of the power tool. Upon completion of that conversation, the representative may offer to the customer a coupon for the purchase of the power saw for which the consumer inquired, and may provide the coupon via the cube. The provided coupon may be printed at the Kiosk or may be imported to a cube already existing on the user's portable device. The coupon and/or cube may be passed to the customer by methods known to those skilled in the art, such as, for example, via NFC, Bluetooth, QR code, and the like.

It can be appreciated by those skilled in the art that A customer may choose to receive a coupon or additional information via the acceptance of a cube from the manufacturer or through more conventional means, such as, for example, a text or email message. In addition to offering discounted information, the consumer may be informed about where in the store the item exists and/or where possible accessories are available. Even without the Kiosk, similar results may be obtained by allowing a consumer to link to at least one cube via a mobile device. For example, a QR code or other addressing technique may be employed at the point of purchase and/or at the point of display for the desired item. A consumer interested in more information about a power saw, for example, may choose to import a cube to their device which has information regarding at least the power saw. The newly accessed cube may include the same functionality as discussed above and may additionally take advantage of location-based information to provide the consumer with addition product information and/or advertisements targeted to the consumer.

Although a cube may be deleted by the user, the addition of a manufacturer's cube and/or the association of such information to a portion of an existing cube may allow for the continued tracking of a consumer's behavior which may allow for the optimizing of ad and/or coupon delivery. For example, a particular manufacturer cube focused on a particular model of automobile may allow the originator of the cube, in the case the automobile manufacturer, to track the holder of the cube to determine, for example, what other car dealerships are being visited. Thus, the automobile manufacturer may determine which other types of cars the prospective buyer is considering and may deliver to the prospective consumer advertisements which may be focused on product comparisons, for example.

As will be appreciated by one skilled in the art, the delivery of ads and the acceptance of other information may be controlled by the creator and/or user of the cube. Similarly, creators of a cube may have remote access to a cube and the ability change or alter cube through platforms such as, for example, Unity or HTML5. The use of Unity as an API design choice allows for a faster alteration of the cube code and allows for much faster compatibility conversion of information types. Unity may also be more efficient to transmit over small bandwidths.

Utilizing the aforementioned embodiment utilizing Unity, the cubes may comprise one or more containers for holding and linking content, which may comprise arrays having respective variables within a series of “compartments”, where each compartment can contain a value. The array configuration may be advantageous where a collection of values or objects are being processed together. Arrays can also be iterated to sequentially examine each item in the array to inspect or perform functions on each item in turn. There are many types of containers in Unity, and those using arrays may comprise built-in arrays, JavaScript arrays, ArrayLists, Hashtables, Generic Lists, Generic Dictionaries, multidimensional arrays, etc. Because Unity is built on Mono, which may be thought of as an open-source implementation of .Net, Unity has access to most of .Net's collection types. The exemplary arrays referenced above may be thought of as standard .Net types, with the exception of the Javascript array, which is essentially a wrapper for the ArrayList class and a type that is added into the Unity Engine.

Built-in arrays are the most basic arrays, and may be generated using JavaScript or C#, and typically have a fixed-size which is chosen when the array is declared. Despite the limitation of having a fixed size, built-in arrays are advantageous in that they possess very fast performance Thus, built-in arrays may be the best choice if cubes are being generated for a platform in which fast performance is needed from the code (e.g., for a smartphone application). This type of array may also be used in situations where a cube is linked or associated with a varying number of items; a maximum number of objects may be defined for the array. Some of the elements in the array may be set to null when they're not required, and the code may be designed around this. For example, for the number of active links in a cube face, an array of size 20 may be set, allowing a maximum of 20 active links at any one time.

Javascript arrays in unity are a special class that is provided in addition to the standard .Net classes. Unlike built-in arrays, JavaScript arrays are dynamic in size, meaning a fixed size need not be specified. Items in the array may be added or removed, and the array will grow and shrink in size accordingly. Also, object types do not have to be specified beforehand, so that objects of any type may be stored into a JavaScript array, even mixed types in the same array. ArrayLists are a .Net class, and are very similar to the JavaScript array, and are available in both JavaScript and C# Like JavaScript arrays, ArrayLists are dynamic in size, allowing the array will grow and shrink in size to fit. ArrayLists are also untyped, so items of any kind may be added, including a mixture of types in the same ArrayList. Hashtables are a type of array where each item is made up of a “key and value” pair. Its use is advantageous in situations where a quick look-up based on a certain value is needed. Here, the information that is used to perform the look-up is the “key”, and the object that is returned is the “value”. This is similar to the type of data in a GET or POST request, where every value passed has a corresponding name. With a Hashtable however, both the keys and the values can be any type of object. Hashtables may be advantageous for situations where a user wants to be able to quickly pick out a certain item from a collection, using some unique identifying key, similar to selecting a record from a database using an index.

Generic lists are also similar to the JavaScript array and the ArrayList, in that they have a dynamic size, and support arbitrary adding, getting and removing of items. One difference with the Generic List (and all other ‘Generic’ type classes), is that a user should explicitly specify the type to be used when it is declared (e.g., the type of object that the list will contain). Once declared, objects of the specific type may be added. Such a configuration may be advantageous in that use of the generic list removes the need to do type casting of the values for retrieval, which also improves performance, compared to configurations such as ArrayLists. Generic dictionaries are another generic class and are similar to hashtables. A generic dictionary provides a structure for quickly looking up items from a collection, but requires key and value types to be specified up front. Because of this, generic dictionaries provide similar advantages in that no casting is needed, and provide additional performance improvements compared to hashtables.

Multidimensional arrays, such as a 2D array may be advantageous for applications where data is to be distributed through a mapped area, such as a face of a cube. A map array may be configured to have a predetermined width and a height, and data may be embedded in portions (or cells) of the map. Of course, it should be understood by those skilled in the art that arrays may be constructed from more than two dimensions, such as a 3D array or a 4D array. A multi-dimensional array may be configured in a number of different manners, including “real” and “jagged” arrays. With a “real” array, the array may be specified having a fixed width and height, where locations, for example, in a 2D array may be specified as “Array[x,y].” Jagged arrays may be created by using nested one-dimensional arrays. For example, a jagged array may be configured with a one-dimensional outer array (representing rows), and each item contained in this outer array is actually an inner array which represents the cells in that row. A location in a jagged array may be specified as “Array[y][x].” While real arrays are simpler to use, jagged arrays may be advantageous in that each “inner” array doesn't have to be the same length as the “outer” array (hence the origin of the term “jagged”).

Of course, as indicated above, cubes may be constructed from a markup language such as HTML, and specifically the current HTML 5. In addition to specifying markup, HTMLS specifies scripting application programming interfaces (APIs) that can be used with JavaScript. Existing document object model (DOM) interfaces are extended and updated APIs, such as canvas element for immediate mode 2D drawing, timed media playback, offline web applications, document editing, drag-and-drop, cross-document messaging, browser history management, MIME type and protocol handler registration, microdata, and web storage, among others, are provided. It should be appreciated by those skilled in the art that the disclosed cube configuration provides numerous advantages for displaying, interacting and processing data.

The cubes disclosed herein may be equipped with further functionalities to improve functionality. In one exemplary embodiment, a cube may detect the operating system in use by the user and may employ a different set of operating code to enhance and/or provide compatibility. In an embodiment of the present invention, the cube may ping the user's device to identify the operating system being employed and may only provide a cube compatible with the identified operating system. Compatible cube code may be resident local to the user's interaction and/or may be provided remotely. For example, a user may request a cube and/or access to a cube from a mobile device to a locally resident cube, such as at a brick and mortar retail location, or remote PC, for example. The locally resident cube may ping the user's mobile device to determine what operating system is being employed. With the assumption that such a cube is likely to encounter mobile devices with having one of only a handful of commercially available operating systems, the local cube may have local access to compatible cubes. For example, iOS compatible cubes may be resident locally to the retail store which may allow for a real time transfer of the cube without a remote communications delay. If a compatible cube does not exist local to the retail store cube, compatible cubes may be remotely retrieved and delivered through the local cube.

As would be appreciated by those skilled in the art, a mobile device may call for the delivery of a compatible cube directly from a remote source. For example, a local cube may provide a link to the mobile device which may allow the mobile device to download a compatible cube. The local cube may also provide update to new and/or existing cubes in the same manner discussed above. Whether directly to the mobile device and/or through the locally resident cube, updates may be provided to a user as needed. Such updates may include not only updates to the operational code of a cube, but also to the cube's content and to other data aspects. Certain configurations may allow for the importation of certain information and/or code to a mobile device. Under one exemplary embodiment, a cube may be first loaded with a standard and/or predetermined background. In this way, the speed of cube transfer may be increased to allow for a more “real time” delivery of the cube regardless of connection speed and/or type.

Under one exemplary embodiment, a cube may also have at least one social network aspect and may allow for the aggregation and or presentation of one or more social networking channels. For example, one or more sides of the cube may be used to view and/or interact with an existing social network and may allow for control over multiple platforms through a single source. The accessing of an existing social network may provide the user with full and/or abbreviated access/presentation of the desired social network site dependent on user rules. For example, access to a Facebook account may be limited to a portion of the Facebook information feed available and may be accessible on one side of a cube. In this way, for example, a user may limit the amount of viewed information to make more manageable the viewing of wanted versus unwanted information. More specifically, the user may be able to block various side banner ads, picture streams and other disparate information feeds from within at least one social media information source. Further security provisions, such as parental blocks, anonymous browsing and the like are contemplated in the present disclosure.

In addition to receiving information, users may send information and publish content as well. For example, if a user wishes to provide information pertaining to an item, such as a vehicle, a cube may provide information about the car not otherwise available on traditional media platforms where a static view of pictures may be presented. A cube may contain within it a 3D image of the vehicle, and may, on each relevant side of the cube, have a corresponding 2D image available to the user if so selected. More specifically, using a transparent cube as described herein, may allow for the user to see a 3D image of a vehicle while viewing at least one side of the cube having viewable information related to vehicle, such as, for example, price, condition, make, model, location and service history. Another user wising to take a closer look at an individual side may then choose to select a corresponding side which may then reveal to the user a 2D image representative of, for example, the front view of the car.

As discussed above, the cube interfaces are applicable to computing devices, such as terminals, personal computers, etc., as well as mobile terminals. A mobile terminal (or “portable computing device”) as used herein comprises at least one wireless communications transceiver. Non-limiting examples of the transceivers include a GSM (Global System for Mobile Communications) transceiver, a GPRS (General Packet Radio Service) transceiver, an EDGE (Enhanced Data rates for Global Evolution) transceiver, a UMTS (Universal Mobile Telecommunications System) transceiver, a WCDMA (wideband code division multiple access) transceiver, a PDC (Personal Digital Cellular) transceiver, a PHS (Personal Handy-phone System) transceiver, and a WLAN (Wireless LAN, wireless local area network) transceiver. The transceiver may be such that it is configured to co-operate with a predetermined communications network (infrastructure), such as the transceivers listed above. The network may further connect to other networks and provide versatile switching means for establishing circuit switched and/or packet switched connections between the two end points. Additionally, the device may include a wireless transceiver such as a Bluetooth adapter meant for peer-to-peer communication and piconet/scatternet use. Furthermore, the terminal may include interface(s) for wired connections and associated communication relative to external entities, such as an USB (Universal Serial Bus) interface or a Firewire interface.

Under certain embodiments, the cubes may be configured to not only present content, but to monitor content as well. Using page tags, web bug or web beacon or similar technology, each side of a cube may be configured to allow tracking of cube face exposures and interactions (i.e., clicking and/or accessing content). A web beacon (page tag, web bug, etc.) is an object that may be embedded in a cube face comprising content and is preferably invisible to the user, but allows checking that a user has viewed the cube face. Such a configuration is particularly advantageous page tagging (via the cube face) for Web analytics. When implemented using JavaScript, they may be called JavaScript tags. In addition to content, cubes may be embedded with specialized code that communicates with a mobile device's operating system and/or application layer to monitor mobile terminal usage and events. Mobile terminal events may be monitored, where the events may include, for example, substantially non-user-initiated incidents such as battery status change, and the like. The actions may include substantially user-initiated intentional activities and incidents, for example use of the web browser, movements, reading a message, etc.

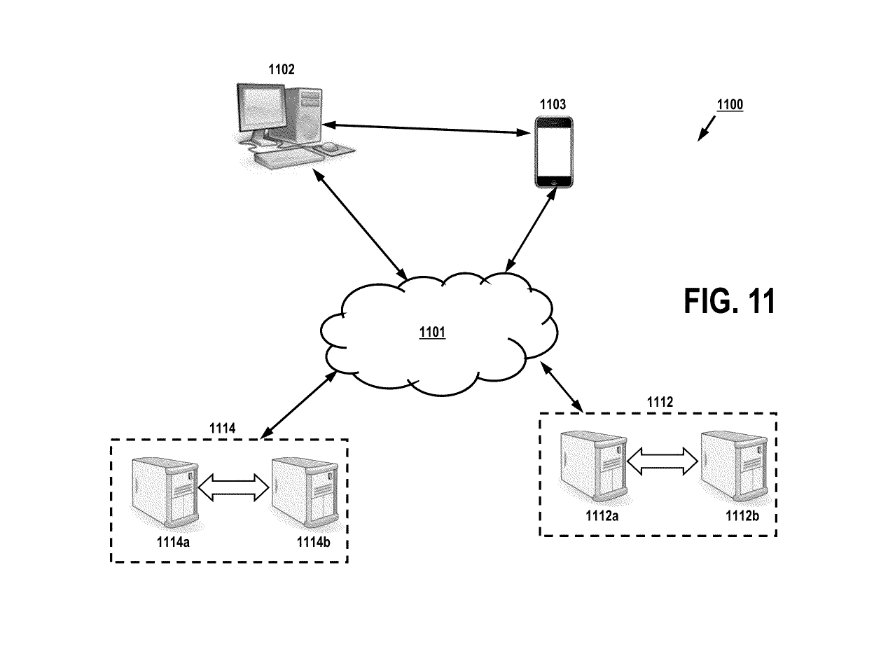

Turning to FIG. 11, an exemplary system architecture is illustrated, where a central server location 1114 is responsible for creating, managing and/or distributing cubes and related contact to network 1101. In this simplified example, it should be understood by those skilled in the art that the term “server” as used herein may comprise a single server, or may include multiple servers (1114a-b) in communication with one another. In addition to cube creation/management, central server location 1114 may include content servers for providing content for respective cubes. Thus, in the example of FIG. 11, server 1114a may be configured to package cube content provided by server 1114b. The content may include web pages, metadata, audio/video, images, text, etc. embedded on one or more respective sides of a cube. Furthermore, the delivered content via servers 1114a-b may be advantageously presented such that cubes contain related content, where one side of the cube contains interactive web content, while other sides contains interactive audio content, video content, metadata text and the like. Furthermore, interactive content, such as advertisements, may be packaged by the system so that advertisements may be bundled with relevant content to allow for more focused packet-based advertisement delivery. Furthermore, as a user interacts with a delivered cube via 1102, 1103, content on a respective side of the cube may be updated via 1114a-b.

The system of FIG. 11 may further comprise a back-end system 1112, which may comprise one or more servers (1112a-b) configured to perform user analytics on delivered cubes. Data relating to content in the cube may include a “cookie”, also known as an HTTP cookie, which can provide state information (memory of previous events) from a user's cube interaction and return the state information to a collecting site (1112). The state information can be used for identification of a user session, authentication, user's preferences, shopping cart contents, or anything else that can be accomplished through storing text data on the user's computer (1102, 1103).

When setting a cookie for a cube, under one embodiment, transfer of content via a cube such as Web pages follows the HyperText Transfer Protocol (HTTP). If a user requests a web page through interaction with the cube, the cube browsers request a page from web servers (e.g., 1114b) by sending a HTTP request. The server replies by sending the requested page preceded by a similar packet of text, called “HTTP response.” This packet may contain lines requesting the browser to store cookies. The server sends lines of Set-Cookie only if the server wishes the browser to store cookies. Set-Cookie is a directive for the browser to store the cookie and send it back in future requests to the server (subject to expiration time or other cookie attributes), if the browser supports cookies and cookies are enabled. The value of a cookie can be modified by sending a new Set-Cookie: name=newvalue line in response of a page request. The cubebrowser then replaces the old value with the new one. Cookies can also be set by JavaScript or similar scripts running within the browser. In JavaScript, the object document.cookie may be used for this purpose.

Various cookie attributes can be used for a cube: a cookie domain, a path, expiration time or maximum age, “secure” flag and “HTTPOnly” flag. Cookie attributes may be used by browsers to determine when to delete a cookie, block a cookie or whether to send a cookie (name-value pair) to the collection site 121 or content site 125. With regard to specific “cookies”, a session cookie may be used, which typically only lasts for the duration of users using the website. A session cookie for a cube may be created when no expires directive is provided when the cookie is created. In another embodiment, a persistent cookie (or “tracking cookie”, “in-memory cookie”) may be used, which may outlast user sessions. If a persistent cookie has its Max-Age set to 1 year, then, within the year, the initial value set in that cookie would be sent back to a server every time a user visited that server via one or more faces of the cube. This could be used to record information such as the type of cube used, a specific face of the cube that was used to initially being the user initially to the website.

Also, a secure cookie may be used when a browser is visiting a server via HTTPS, ensuring that the cookie is always encrypted when transmitting from client to server. An HTTPOnly may also be used. On a supported cube browser, an HTTPOnly session cookie may be used for communicating HTTP (or HTTPS) requests, thus restricting access from other, non-HTTP APIs (such as JavaScript). This feature may be advantageously applied to session-management cookies.

By utilizing back-end processes in 1112, cube developers may more accurately track user interactions with cubes and provide additional information for bundling cubes for users that are of related interests.

The system of FIG. 11 further comprises computing devices 1102 and 1103, which, in this example, comprise a personal computer 1102 and mobile terminal 1103. It is understood that any processing devices having similar functionalities may be readily substituted for devices 1102-1103, and that the specific example is provided for illustrative purposes only. Devices 1102 and 1103 are configured to communicate with network 1101, where they may receive and transmit cubes, as well as communicate data relating to their interaction with the cubes. Additionally, devices 1102 and 1103 may communicate with each other as shown, where, for example, device 1102 may transmit a cube to device 1103 and vice versa. In one embodiment, if devices 1102 and 1103 are utilizing the same cube, data from the interaction with the cube may be transmitted to each respective device. The data relating to the interaction of cubes between devices 1102-1103 may also be transmitted to back-end 1112 for further processing.

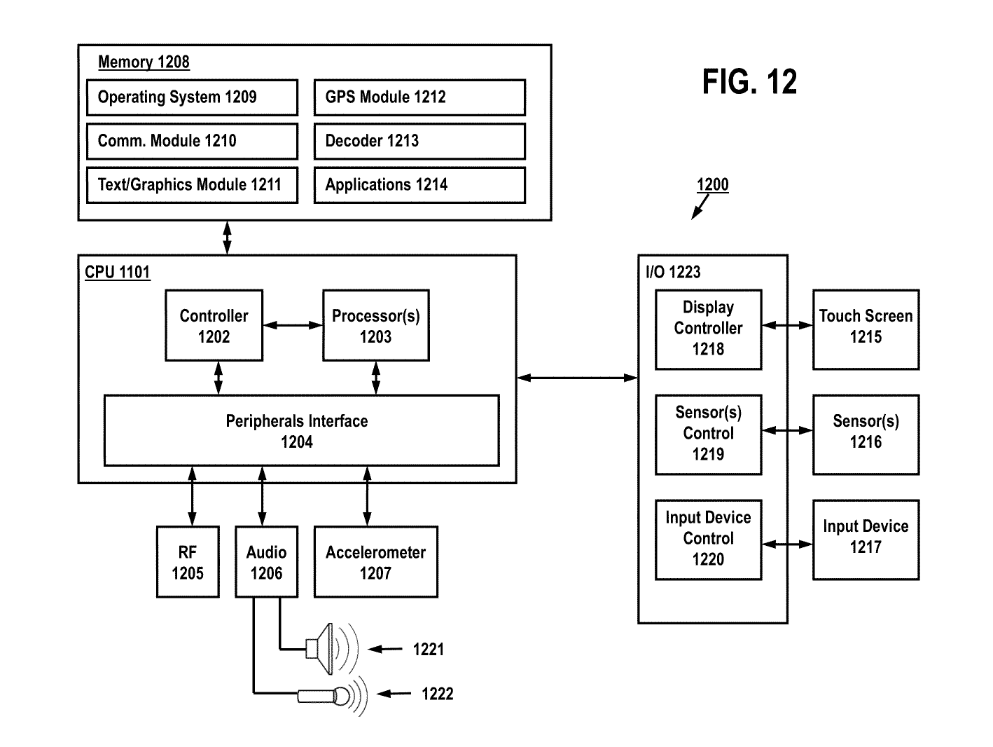

FIG. 12 is an exemplary embodiment of a portable computing device 1200 which may function as a terminal, and may be a smart phone, tablet computer, laptop or the like. Device 200 may include a central processing unit (CPU) 1201 (which may include one or more computer readable storage mediums), a memory controller 1202, one or more processors 1203, a peripherals interface 1204, RF circuitry 1205, audio circuitry 1206, a speaker 1221, a microphone 1222, and an input/output (I/O) subsystem 1223 having display controller 1218, control circuitry for one or more sensors 1216 and input device control 1214. These components may communicate over one or more communication buses or signal lines in device 200. It should be appreciated that device 200 is only one example of a portable multifunction device 200, and that device 200 may have more or fewer components than shown, may combine two or more components, or a may have a different configuration or arrangement of the components. The various components shown in FIG. 12 may be implemented in hardware or a combination of hardware and tangibly-embodied software, including one or more signal processing and/or application specific integrated circuits.

Data communication with device 1200 may occur via a direct wired link or data communication through RF interface 205, or through any other data interface allowing for the receipt of data, including cube data, in digital form. Audio signals generated or received through a cube may be reproduced on device 200 through streaming media received through 1205, or digital files stored in memory 208 and executed through one or more applications (214) stored in memory 1208 such as a media player that is linked to audio circuitry 1206. Decoder 1213 is capable of providing media decoding or transcoding capabilities for received media, and may also be enabled to provide encoding capabilities as well, depending on the needs of the designer.

Memory 1208 may also include high-speed random access memory (RAM) and may also include non-volatile memory, such as one or more magnetic disk storage devices, flash memory devices, or other non-volatile solid-state memory devices. Access to memory 1208 by other components of the device 1200, such as processor 1203, decoder 1213 and peripherals interface 1204, may be controlled by the memory controller 1202. Peripherals interface 1204 couples the input and output peripherals of the device to the processor 1203 and memory 1208. The one or more processors 1203 run or execute various software programs and/or sets of instructions stored in memory 1208 to perform various functions for the device 1200 and to process data. In some embodiments, the peripherals interface 1204, processor(s) 1203, decoder 1213 and memory controller 1202 may be implemented on a single chip, such as a chip 1201. In some other embodiments, they may be implemented on separate chips.

The RF (radio frequency) circuitry 1205 receives and sends RF signals, also known as electromagnetic signals. The RF circuitry 1205 converts electrical signals to/from electromagnetic signals and communicates with communications networks and other communications devices via the electromagnetic signals. The RF circuitry 1205 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 1205 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication.

The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this document.

Audio circuitry 1206, speaker 1221, and microphone 1222 provide an audio interface between a user and the device 1200. Audio circuitry 1206 may receive audio data from the peripherals interface 1204, converts the audio data to an electrical signal, and transmits the electrical signal to speaker 221. The speaker 1221 converts the electrical signal to human-audible sound waves. Audio circuitry 1206 also receives electrical signals converted by the microphone 1221 from sound waves, which may include audio. The audio circuitry 1206 converts the electrical signal to audio data and transmits the audio data to the peripherals interface 1204 for processing. Audio data may be retrieved from and/or transmitted to memory 1208 and/or the RF circuitry 1205 by peripherals interface 1204. In some embodiments, audio circuitry 1206 also includes a headset jack for providing an interface between the audio circuitry 206 and removable audio input/output peripherals, such as output-only headphones or a headset with both output (e.g., a headphone for one or both ears) and input (e.g., a microphone).

I/O subsystem 1223 couples input/output peripherals on the device 1200, such as touch screen 1215 and other input/control devices 1217, to the peripherals interface 1204. The I/O subsystem 1223 may include a display controller 1218 and one or more input controllers 1220 for other input or control devices. The one or more input controllers 1220 receive/send electrical signals from/to other input or control devices 1217. The other input/control devices 1217 may include physical buttons (e.g., push buttons, rocker buttons, etc.), dials, slider switches, joysticks, click wheels, and so forth. In some alternate embodiments, input controller(s) 1220 may be coupled to any (or none) of the following: a keyboard, infrared port, USB port, and a pointer device such as a mouse, an up/down button for volume control of the speaker 1221 and/or the microphone 1222. Touch screen 1215 may also be used to implement virtual or soft buttons and one or more soft keyboards.

Touch screen 1215 provides an input interface and an output interface between the device and a user. The display controller 1218 receives and/or sends electrical signals from/to the touch screen 1215. Touch screen 1215 displays visual output to the user. The visual output may include graphics, text, icons, video, and any combination thereof (collectively termed “graphics”). In some embodiments, some or all of the visual output may correspond to user-interface objects. Touch screen 1215 has a touch-sensitive surface, sensor or set of sensors that accepts input from the user based on haptic and/or tactile contact. Touch screen 1215 and display controller 1218 (along with any associated modules and/or sets of instructions in memory 1208) detect contact (and any movement or breaking of the contact) on the touch screen 1215 and converts the detected contact into interaction with user-interface objects (e.g., one or more soft keys, icons, web pages or images) that are displayed on the touch screen. In an exemplary embodiment, a point of contact between a touch screen 1215 and the user corresponds to a finger of the user. Touch screen 1215 may use LCD (liquid crystal display) technology, or LPD (light emitting polymer display) technology, although other display technologies may be used in other embodiments. Touch screen 1215 and display controller 1218 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 1215.

Device 1200 may also include one or more sensors 1216 such as optical sensors that comprise charge-coupled device (CCD) or complementary metal-oxide semiconductor (CMOS) phototransistors. The optical sensor may capture still images or video, where the sensor is operated in conjunction with touch screen display 1215. Device 1200 may also include one or more accelerometers 1207, which may be operatively coupled to peripherals interface 1204. Alternately, the accelerometer 1207 may be coupled to an input controller 1214 in the I/O subsystem 1211. The accelerometer is preferably configured to output accelerometer data in the x, y, and z axes.

In one embodiment, the software components stored in memory 1208 may include an operating system 1209, a communication module 1210, a text/graphics module 1211, a Global Positioning System (GPS) module 1212, audio decoder 1213 and applications 1214. Operating system 1209 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components. Communication module 1210 facilitates communication with other devices over one or more external ports and also includes various software components for handling data received by the RF circuitry 1205. An external port (e.g., Universal Serial Bus (USB), Firewire, etc.) may be provided and adapted for coupling directly to other devices or indirectly over a network (e.g., the Internet, wireless LAN, etc.).

Text/graphics module 1211 includes various known software components for rendering and displaying graphics on the touch screen 1215, including components for changing the intensity of graphics that are displayed. As used herein, the term “graphics” includes any object that can be displayed to a user, including without limitation text, web pages, icons (such as user-interface objects including soft keys), digital images, videos, animations and the like. Additionally, soft keyboards may be provided for entering text in various applications requiring text input. GPS module 1212 determines the location of the device and provides this information for use in various applications. Applications 1214 may include various modules, including address books/contact list, email, instant messaging, video conferencing, media player, widgets, instant messaging, camera/image management, and the like. Examples of other applications include word processing applications, JAVA-enabled applications, encryption, digital rights management, voice recognition, and voice replication. Under one embodiment, a cube may have access to any or all of features in memory 1208.

Utilizing any of the hardware illustrated above, the cubes may be suitably configured to take advantage of these features to provide a more personalized cube experience. For example, cubes may utilize GPS for location-based content delivery. Similarly, accelerometers may be used to control cube interaction, and even provide a mechanism for transferring cubes from one device to another. For example, a cube displayed on one device may detect the presence of another device in proximity. By swiping or gesturing in the direction of the device, cube data and/or a copy of the cube itself may be transmitted to the other device. Devices that are linked to each other (e.g., multiple devices registered to a group or family) may have the cube configured such that the cube on one device may activate features on the other device (e.g., play content on the other device's speakers). It should be understood by those skilled in the art that a multitude of different features may be enabled through the present disclosure.

In a retail application, providing access to information in a store via a cube (as discussed above) may include product information, pharmacy information/interaction, coupon delivery, customer feedback, purchase tracking, shopping tracking (seeing where you go in the store, where you look, what most interests you the shopper).

The cube may also provide for the limiting of information distribution and to provide customizing information in a more relevant way. Information posted to a cube may be given a time and/or location stamp and may be unlocked by at least one other user according to at least one set of rules based on, in part, the time and/or location stamp associated with the posted information. For example, a user may post information from a particular location to their cube and may limit access to the information to other authorized viewers of their cube within the same location. By way of further example, a first user may be in a bar with friends and may post to a cube pictures of the festivities which occurred during the time spent in the bar. These images and/or the cube itself may be locked according to location (i.e., the bar) by the first user so as to restrict access to the images and/or cube to those not proximate to the bar. Moreover, as discussed herein, the user may also have access to the images and/or cube limited to other first user authorized users. Thus, access to the images and/or cube may be gained by at least one first user authorized user when at least proximate to the saloon. So, for example, if at least one first user authorized user enters the saloon at a later date and/or time, the first user authorized user may view and/or interact with the images and/or cube posted in that location by the first user.

Limiting information in this way has many advantages over the current state of social networks Importantly, such restrictions limit third party knowledge of the first user's whereabouts and may protect the first user's privacy—even if temporally. This may be useful in combating nefarious actors, such as those who may, for example, seek to take advantage of the first user's absence from their place of residence and/or work. Protect of the first user's privacy may also extent to the fact that the first user was in a bar—information which may not wish to be shared by the first user to all of the authorized users. For example, the first user's parents may be authorized users but may not have access to the images unless they patronize the bar (i.e., are in the same geographic location).

In another exemplary embodiment, time may be used as a way to allow or restrict access to content. If content is delivered to a device, such as promotional content, the cube may configured such that one face of the cube may contain time-restricted content that will be displayed and/or allowed to be accessed within a specific time frame. It is worth noting that, while one face may contain time-restricted content, other faces may have no such restrictions, or alternately may contain different time restricted content. The faces may also be arranged so that one or more faces automatically update or replace content based on a predetermined time schedule. The time restrictions may further be combined with geographic restrictions, so that specific content for a cube may have different (or no) time restrictions based on the location of the device.

By virtue of presenting content in a polyhedron format (cube), the display of content makes it easier to view and/or interact with content, particularly on a smaller screen. In a mobile environment, information may be presented on a shape which provides at least one focus point within the display area of the mobile device. The at least one focus point may be the cube as a whole (or the shape presented), for example, or a portion of the cube. For example, an image may be included on a pane of the cube which may present a focus area within the cube and/or shape presented. Furthermore, cubes may be configured to allow users to add content within the confines of the cube, where the content may be static or interactive.

The present disclosure provides for the simultaneous presentation of a myriad of information and content types, the limiting of information distribution, and improved relevancy of provided information, through the use of a cube. The cube allows for an improved use of “on-screen real estate,” which allows improved user focus. A user may have access to one cube or a plurality of cubes. For example, one or more cubes may be associated with a user account, and as such may be selected, designed, or otherwise provided by or for the user. That is, the user may select content and/or features for association with a cube, or, more particularly, with individual faces of the cube. Further, the user may have access to one or more cubes designed or otherwise provided by another. For example, one or more cubes associated with a third party, such as on a social network site, may be accessible to a fan, friend, associate, linked person, or the like.

Accordingly, the cube may also have at least one social network aspect and may allow for the aggregation and or presentation of one or more social networking channels. The accessing of an existing social network may provide the user with full and/or abbreviated access/presentation of the desired social network site, such as dependent on user rules. For example, access to a Facebook account may be limited to a portion of the Facebook information feed available and may thus be accessible on one side of a cube. In this way, for example, a user may limit the amount of viewed information to make more manageable the viewing of wanted versus unwanted information. For example, the user may block various side banner ads, picture streams and other disparate information feeds.

As mentioned above, a cube may be comprised of a plurality, such as six (6), faces, and content and/or features may be provided on each face of the cube. Of course, the cube may have any number of faces, and the cube may have faces sized and shaped accordingly so as to accommodate a desired number of faces for specific content and content types. By way of non-limiting example, a cube may be comprised of six (6) joined square shapes. Alternately, a cube may comprise six triangular faces joined at a single point at one point common to all of the plurality of triangular faces, and joined at a hexagonal face at the leg of each triangular face opposite the commonly-joined point. One skilled in the art would readily recognize that a plurality of possibilities and configurations are possible.

The faces of the cube may be simultaneously viewable by a user, irrespective of which face(s) is (are) directly within view of the user. Additionally and alternatively, content associated with faces oblique to the user's direct view may be ghosted, transparent, opaque, underplayed (with the direct view face overlaid, and hence more significantly visible), represented iconographically (i.e., an arrow represents a video, a note represents music), or the like.

The user may preferably be enabled to graphically “rotate,” or otherwise “move,” the faces of the cube into direct view, such as using a finger, pointer, cursor, or the like. Such rotation may be limited (such as only in the x axis, or only in the y axis, or only in the x and y axes) or unlimited (such as free rotation through the x, y and z axes). The rotation may comprise an initial “grab” by the user, such as by a user indication using a mouse cursor, finger, or the like, followed by a user indication of movement. For example, the greater the extent of the user movement in a given direction, the greater the graphical rotation in that direction, and through the faces, which may occur. Alternatively, a user movement in a given direction may indicate a rotation only to the next available face following rotation in the indicated direction. Similarly, the extent of rotation in any given may be dictated by the speed of the user's indication in that direction—that is, a faster user movement may dictate a greater rotation. Likewise, a user may provide a movement or rotation indication using provided graphical user controls, such as directional on-screen arrows or the like.

The user may access the content indicated by a given face or side by accessing that face. For example, a particular face may be rotated into an at least partial view and, more preferably, into a direct view. Thereafter, the user may “release” the cube from the aforementioned “grab” and consequent rotation indication, and may indicate an access request. The access request may comprise a user indication to access the content associated with the accessed cube face.

Content access may include, for example, the graphical providing of the accessed content in an exploded window. In a preferred embodiment, the provided content at least partially includes the content indicated on the accessed face. Moreover, the type of content may be that indicated by the iconography associated with the accessed face.

In order to provide the accessed content, and the aforementioned graphical cube behavior, the cube may ping the user's device to identify the operating system being employed. Thereby, only the cube or cube features that are compatible with the identified operating system may be provided. Compatible cube code may be resident local to the user's interaction and/or may be provided remotely, and, irrespective of the location of the compatible cube code, the compatibility assessment may be made locally or remotely, and may be made upon first use of an identifiable device, or may be made upon each instantiation of cube access.

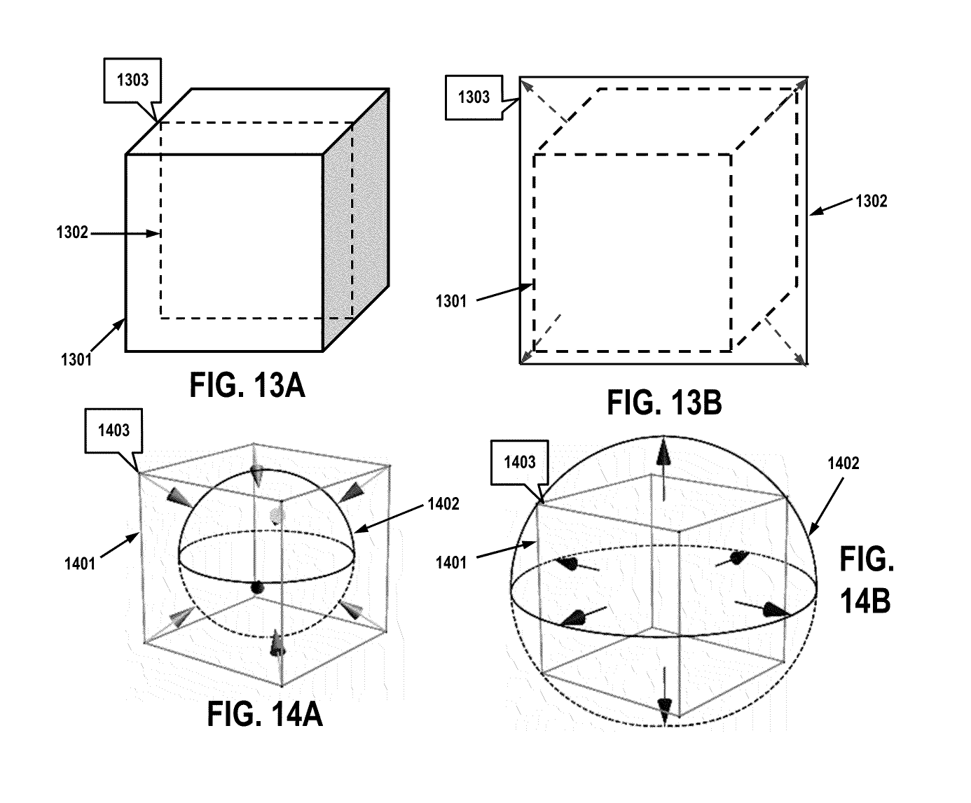

Turning now to FIG. 13A, another exemplary embodiment is provided, where a cube 1301, such as those described in the embodiments above, is configured to also contain a secondary form comprising internal content 1302 (or “nested” content) which may be a web page, document, image, animation, interactive document, or the like. In this example, nested content 1302 is displayed simultaneously with content on the face of cube 1301, and may be displayed transparently, so as not to interfere excessively with content on the face of cube 1301. Under one embodiment, nested content 1302 may rotate or otherwise move together with the rotation and/or movement of cube 1301. In another embodiment, the position of nested content 1302 would remain fixed inside cube 1301. Here, nested content 1302 would be configured to always face the user, even though cube 1301 is being rotated or otherwise manipulated by a user.

The substance of nested content 1302 (e.g., what is displayed on the page) may also be fixed, meaning that the same content would be displayed regardless of which face of cube 1301 is being viewed or interacted with by a user. Such a configuration would be advantageous for advertising applications, where cubes or cube content may be sponsored by a specific advertiser. Here, the advertiser's logo or similar indicia would be displayed continuously throughout the interaction of the cube. In another embodiment, the substance of nested content 1302 is linked to each face of a cube. As a user rotates cube 1301 from one face to another, the content of nested content 1302 may change accordingly. This configuration is particularly advantageous for providing further information that supplements the cube content.

For example, cube 1301 may be configured as a music application, where each face of the cube represents a different music station or genre. When a user activates music on one face of cube 1301, nested content 1302 may display artist information, images, etc. as it pertains to the music being played. Other information, such as song lyrics, or links for purchasing music may be provided as well. In another example, each face of cube 1301 may represent commercial offerings, such as homes/real estate for sale. As a user rotates and browses through the faces of cube 1301, nested content 1302 may display an image, as well as background and contact information, of the seller or broker for the commercial offerings. A similar configuration can be arranged for virtually any commercial offering, such as the sale of automobiles (where the dealer information would be nested) or goods on a commercial site (e.g., eBay, where the seller information on associated goods is nested).

In one embodiment, a user may activate nested content 1302 utilizing a popup icon 1303, which may be continuously displayed. In another embodiment, popup icon 1303 may be initially hidden until a user's mouse, finger or pen (when using touchscreen technology) traverses some portion of nested content 1302 and/or cube 1301. When popup icon 1303 is activated, nested content is expanded in the example of FIG. 13B for presentation to a user. In this example, activated nested content 1302 is given primary visual status, while cube 1301 is rendered transparent, or invisible, behind the nested content 1302. Once activated, nested content 1302 may be interacted with in a manner suited for the content. For example, if nested content 1302 is a web page, all links and other embedded content may be activated for interaction with a user. In another exemplary embodiment, nested content 1302 may be activated using a link embedded into the nested content itself. In this example, the popup function of icon 1303 would be performed by the link.

Once a user has finished viewing/interacting with activated nested content 1302 in FIG. 13B, the user may simply click on popup icon 1303, which will retract content 1302 into its nested configuration shown in FIG. 13A. In another embodiment, a user may click on an embedded link as discussed above to retract the content in a similar manner. In still another embodiment, the expansion/retraction of nested content may be dependent upon a cursor or touch-screen position of a user, relative to the cube. Thus, activated nested content 1302 may automatically retract as a user moves a cursor away from the general area, or taps a region of the screen that is away from the area of nested content. Placing the cursor or tapping the region, of the cube would automatically expand nested content 1302.

While the examples of FIG. 13A-B illustrate configurations for nesting two-dimensional content within a cube, it is contemplated by the present disclosure to nest three-dimensional content as well. Turning to FIG. 14A, cube 1401 is nested with content 1402, which, in this example, is embodied as a sphere. Utilizing graphical mapping techniques, nested content 1402 may comprise a wrapped image that covers at least a portion of the spherical surface, and may further include interactive links. Similar to the embodiments of FIGS. 13A-B, the activation of popup icon 1403 expands nested content 1402 so that it is given primary visual status, while cube 1401 is rendered transparent or even invisible.

Since nested content 1402 is also three-dimensional, it may me static or capable of moving with cube 1401 during user interaction, similar to the embodiments of FIGS. 13A-B. However, since the three-dimensional surface of nested content 1402 provides a greater area for hosting content, other nesting configurations are possible. For example, the rate of rotation for nested content 1402 may be different from the rate or rotation for cube 1401. Furthermore, nested content 1402 may be static for certain faces of cube 1401, but may be configured to rotate along with the cube when other faces of the cube are selected. Such a configuration provides a content designer with additional features for presenting content in a visually interesting way.

It should be clear to those skilled in the art that the spherical example of FIGS. 14A-B is merely illustrative, and that other configurations are contemplated by the present disclosure. For example, nested content 1402 may be configured as a secondary cube, resulting in a “cube-within-a-cube” arrangement. Other three-dimensional shapes may be used as well. In another example, nested content 1402 may be provided as a three-dimensional rendering of a person or thing. Here, a cube (1401) configured to provide content on various faces relating to an automobile manufacturer, may have a three-dimensional rendering of a vehicle nested within (1402). The rendered vehicle may be configured to be static, or rotate together with the cube (1401). As a popup icon 1403 is activated, the vehicle may expand over the cube for viewing and/or interaction. For interaction, portions of the vehicle, such as the hood, windshield, gas tank, etc., may contain active links to allow a user to further interact with the content of interest (e.g., “click to SEE the statistics of the new XYZ engine”). In other embodiments, one or more portions of the nested content may be animated. Such configurations provide an interesting interaction experience for users to explore and interact with content.

In the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system, comprising:
a communication apparatus for communicating data to a network;
a storage, operatively coupled to the communication apparatus, wherein the storage is configured to store data to be presented to a user via the network; and
a processor, operatively coupled to the storage, wherein the processor is configured to process the data to generate a presentation form for the data, wherein the presentation form comprises:
a polyhedron comprising a plurality of faces, wherein each face of the polyhedron comprises a portion of the data on each face, and
a secondary form, nested within an area of the polyhedron, wherein the secondary form comprises secondary data that is related to the data to be presented to the user,
wherein the processor is further configured to transmit the presentation form to the communication apparatus for presentation to the user.

2. The system of claim 1, wherein the data and secondary data each comprise at least one of graphical data, audio data, streaming media data, video data, text, web page, hyperlink, metadata and image data.

3. The system of claim 2, wherein the processor is configured to group the data on each face of the polyhedron according to a predetermined category, and to configure the secondary form based on the grouping of data.

4. The system of claim 1, wherein the system receives user data in the communication apparatus in response to the transmission of the presentation form.

5. The system of claim 4, wherein the user data comprises data relating to at least one of
(i) the user's exposure to and/or the user's interaction with data from at least one face of the presentation form, and
(ii) the user's exposure to and/or the user's interaction with the secondary data.

6. The system of claim 5, wherein the processor in the system is configured to retrieve further data for the presentation form and transmit the further data to the user in response to receiving the user data.

7. The system of claim 6, wherein the further data comprises additional data relating to at least one of (i) the at least one face the user interacted with, (ii) a face different from the at least one face the user interacted with in the presentation form, and (iii) the secondary form the user interacted with.

8. The system of claim 1, wherein the secondary form is one of (i) a two-dimensional object, and (ii) a three-dimensional object.

9. A portable computing device, comprising:
a communication apparatus for communicating with a network;
a storage apparatus, operatively coupled to the communication apparatus;
a processor, operatively coupled to the storage; and
a user input apparatus, operatively coupled to the processor, wherein the user input apparatus is configured to allow a user to control an aspect of operation in the processor,
wherein the communication apparatus is configured to receive a presentation form from the network, said presentation form comprising
a polyhedron comprising a plurality of faces, wherein each face of the polyhedron comprises different presentation data on each face, and
a secondary form, nested within an area of the polyhedron, wherein the secondary form comprises secondary data that is related to the data to be presented to the user,
wherein the processor is configured to present the presentation form to the user in the portable computing apparatus, and (i) allow the user to control the polyhedron and secondary form via the user input apparatus and (ii) access at least one of the presentation data and secondary data via the user input apparatus.

10. The portable computing device of claim 9, wherein the presentation data and secondary data each comprises at least one of graphical data, audio data, streaming media data, video data, text, web page, hyperlink, metadata and image data.

11. The portable computing device of claim 10, wherein the presentation data is grouped on each face of the polyhedron according to a predetermined category, and wherein the secondary form is configured based on the grouping of data.

12. The portable computing device of claim 9, wherein the portable computing device is configured to transmit user data to the communication apparatus in response to the user accessing one of the presentation data and secondary data.

13. The portable computing device of claim 12, wherein the processor in the portable computing device is configured to receive further data for the presentation form via the communication apparatus in response to transmitting the user data.

14. The portable computing device of claim 13, wherein the further data comprises additional data relating to at least one of
(i) the at least one face the user interacted with,
(ii) a face different from the at least one face the user interacted with in the presentation form, and
(iii) the secondary form the user interacted with.

15. The portable computing device of claim 9, wherein the secondary form is one of (i) a two-dimensional object, and (ii) a three-dimensional object

16. A processor-based method for transmitting content over a network, comprising the steps of:
retrieving data to be presented to a user from a storage;
processing the data in a processor to generate a presentation form for the data, wherein the presentation form comprises
a polyhedron comprising a plurality of faces, and wherein each face of the polyhedron comprises a portion of the data on each face, and
a secondary form, nested within an area of the polyhedron, wherein the secondary form comprises secondary data that is related to the data to be presented to the user; and
transmitting the presentation form to a communication apparatus for presentation to the user.

17. The processor-based method of claim 16, wherein the data and secondary data each comprise at least one of graphical data, audio data, streaming media data, video data, text, web page, hyperlink, metadata and image data.

18. The processor-based method of claim 17, wherein the data is grouped on each face of the polyhedron according to a predetermined category, and the secondary data is configured on the secondary form based on the grouping of data.

19. The processor-based method of claim 16, further comprising the steps of receiving user data in the communication apparatus in response to the transmission of the presentation form.

20. The processor-based method of claim 19, wherein the user data comprises data relating to at least one of
(i) the user's exposure to and/or the user's interaction with data from at least one face of the presentation form, and
(ii) the user's exposure to and/or the user's interaction with the secondary data.

21. The processor-based method of claim 20, further comprising the steps of retrieving further data for the presentation form and transmitting the further data to the user in response to receiving the user data.

22. The processor-based method of claim 21, wherein the further data comprises additional data relating to at least one of (i) the at least one face the user interacted with, (ii) a face different from the at least one face the user interacted with in the presentation form, and (iii) the secondary form the user interacted with.

23. The processor-based method of claim 16, wherein the secondary form is one of (i) a two-dimensional object, and (ii) a three-dimensional object
